(19) United States
(12) Patent Application Publication
(10) Pub. No.: US 2022/0253284 A1
(43) Pub. Date: Aug. 11, 2022

(54) CONSTANT MULTIPLIER

(71) Applicant: Nuvoton Technology Corporation, Hsinchu Science Park (TW)

(72) Inventor: Tsung-Hsien HSIEH, Taoyuan City (TW)

(21) Appl. No.: 17/552,398

(22) Filed: Dec. 16, 2021

(30) Foreign Application Priority Data
Feb. 9, 2021 (TW) 110104932

(51) Int. Cl. G06F 7/523

(52) U.S. Cl. CPC G06F 7/523

(57) ABSTRACT

A constant multiplier is provided, which calculates a product of a constant C and an input value X. The constant C is N bits and the input value X is M bits, and the input value X is divided into K groups. Each group has a length of L bits. The constant multiplier includes a product pre-calculation circuit, K multiplexers, and (K−1) adders. The product pre-calculation circuit generates integer multiples of the constant C. A selection signal of the j-th multiplexer corresponds to bits ((j+1)*L−1:j*L) of the input value X, and an input signal of each multiplexer is one of the integer multiples of the constant C. An output signal of the j-th multiplexer is left-shifted by j*L bits to generate a shifted output signal. Each adder is connected in series to sum up the shifted output signal corresponding to each multiplexer to obtain the product.

### CROSS REFERENCE TO RELATED APPLICATIONS

This Application claims priority of Taiwan Patent Application No. 110104932 filed on Feb. 9, 2021, the entirety of which is incorporated by reference herein.

### BACKGROUND OF THE INVENTION

### Field of the Invention

The present invention relates to multipliers, and, in particular, to a reconfigurable low-latency constant multiplier.

### Description of the Related Art

In current video, audio, or communication systems, finite-impulse response (FIR) filters are widely used, and FIR filters perform convolution operations on input samples with different filter coefficients, which can be expressed by equation (1):

$$y [ n ] = {\sum }_{k = 0}^{N - 1} {C}_{k} * X [ n - k ] \qquad ( 1 )$$

where Cₖ denotes the k-th filter coefficient; x[n] denotes the n-th input sample; and y[n] denotes the n-th output sample.

If the FIR filter is simply implemented by a multiplier, when the tap of the FIR filter increases, the operation latency, circuit area, and power consumption of the FIR filter will greatly increase. In addition, in a system with a high-tap FIR filter, due to the latency of convolution operations, the group latency and phase response of the FIR filter will deviate from the original design, and it may destroy the phase margin and reduce the system performance.

Traditionally, a constant multiplier is implemented using conversion-based technology, which can convert the constant into another digital representation, and realize the new digital representation through shifters and adders. However, when the representation of a given constant is selected, the related hardware of the traditional constant multiplier will also be fixed and cannot be used for other constants. In addition, the traditional constant multiplier cannot be shared between different constants or coefficients. Therefore, the traditional constant multiplier cannot meet the requirement of being reconfigurable.

### BRIEF SUMMARY OF THE INVENTION

In view of the above, a reconfigurable low-latency constant multiplier is provided to solve the aforementioned problems of the traditional constant multiplier.

In an exemplary embodiment, a constant multiplier is provided. The constant multiplier calculates a product of a constant C and an input value X, wherein the constant C is N bits and the input value X is M bits, and the input value X is divided into K groups, and each group has a length of L bits, where N, M, K, and L are positive integers. The constant multiplier includes a product pre-calculation circuit, K multiplexers, and (K−1) adders. The product pre-calculation circuit is configured to generate a plurality of integer multiples of the constant C. A selection signal of the j-th multiplexer of the K multiplexers corresponds to bits ((j+1)*L−1:j*L) of the input value X, and an input signal of each multiplexer is one of the integer multiples of the constant C, and an output signal of the j-th multiplexer is left-shifted by j*L bits to generate a shifted output signal, where j is an integer between 0 and K−1. Each adder is connected in series to sum up the shifted output signal corresponding to each multiplexer to obtain the product.

In another exemplary embodiment, a constant multiplier is provided. The constant multiplier calculates a product of a constant C and an input value X, wherein the constant C is N bits and the input value X is M bits, and the input value X is divided into K groups, and each group has a length of L bits, where N, M, K, and L are positive integers. The constant multiplier includes a product pre-calculation circuit, K multipliers, and a partial-product summing circuit. The product pre-calculation circuit is configured to generate a plurality of integer multiples of the constant C. A selection signal of the j-th multiplexer of the K multiplexers corresponds to bits ((j+1)*L−1:j*L) of the input value X, and an input signal of each multiplexer is one of the integer multiples of the constant C, and an output signal of the j-th multiplexer is left-shifted by j*L bits to generate a shifted output signal. The shifted output signal corresponding to each multiplexer is divided into a plurality of segments, and every two adjacent segments are separated by L bits, where j is an integer between 0 and K−1. The partial-product summing circuit includes a plurality of first adders and a plurality of second adders. Each first adder calculates a first sum of the shifted output signal of each multiplexer in each segment in parallel, and the first sum corresponding to every two adjacent segments are separated by L bits. Each second adder calculates a second sum of the first sum of each first adder in each segment in parallel to obtain a partial value of the product M in each segment.

### BRIEF DESCRIPTION OF THE DRAWINGS

The present invention can be more fully understood by reading the subsequent detailed description and examples with references made to the accompanying drawings, wherein:

FIG. 1 is a diagram of the constant multiplier in accordance with an embodiment of the invention;

FIG. 2 is a diagram of a conventional constant multiplier;

FIGS. 3A-3B are portions of a diagram of the ripple adder architecture in accordance with the embodiment of FIG. 1;

FIG. 4A is a diagram of the constant multiplier in accordance with another embodiment of the invention;

FIGS. 4B-1 to 4B-4 are portions of a diagram of the partial product summing circuit in accordance with the embodiment of FIG. 4A; and

FIGS. 4C-1 to 4C-2 are portions of a diagram of carry calculation and group summation in accordance with the embodiment of FIGS. 4B-1 to 4B-4.

### DETAILED DESCRIPTION OF THE INVENTION

The following description is made for the purpose of illustrating the general principles of the invention and should not be taken in a limiting sense. The scope of the invention is best determined by reference to the appended claims.

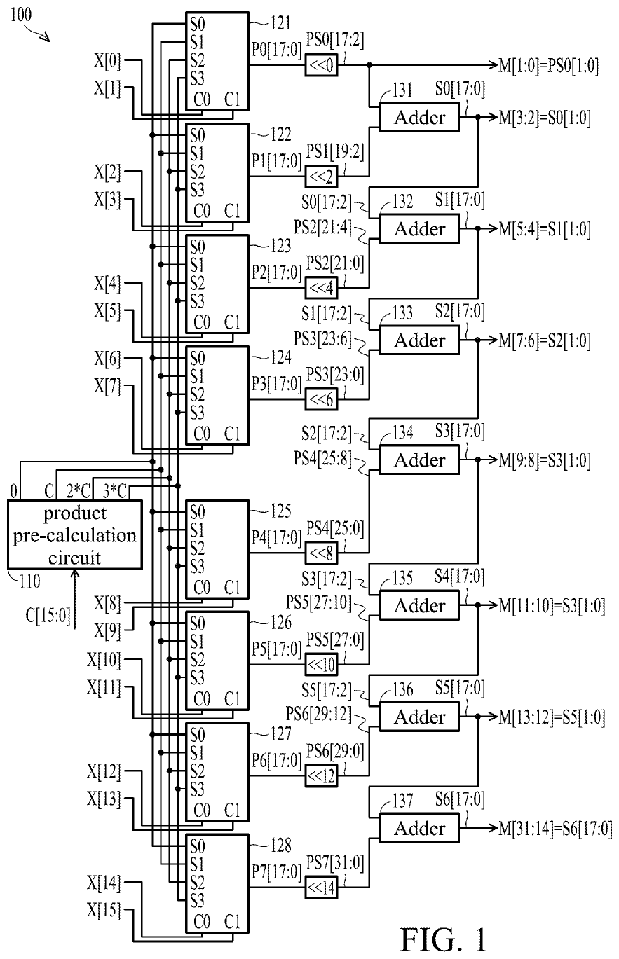

FIG. 1 is a diagram of the constant multiplier in accordance with an embodiment of the invention.

In an embodiment, the case where a signed number X is multiplied by a constant C is considered. The 2's complement of the signed number X with a width of N bits can be expressed by equation (2):

$$X = - {2}^{N - 1} {X}_{N - 1} + {\sum }_{i = 0}^{N - 2} {2}^{i} * {X}_{i} \qquad ( 2 )$$

where i denotes an integer. When the signed number X is multiplied with the constant C with a width of M bits, equation (3) can be obtained as follows:

$$C * X = C * ( - {2}^{N - 1} {X}_{N - 1} + {\sum }_{i = 0}^{N - 2} {2}^{i} * {X}_{j} ) \qquad ( 3 )$$

if the signed number X is divided into K groups, and each group has a length of L, where K*L=N, and K and L are positive integers. Then, equation (3) can be rewritten as equation (4):

$$C * X = {c}^{*} {\sum }_{i = 0}^{L - 1} {2}^{t} {X}_{i} + C * {\sum }_{i = L}^{2 L - 1} {2}^{i} {X}_{i} + … + C * ( {{\sum }^{KL - 2}}_{i = ( K - 1 ) L} {2}^{i} {X}_{i} - {2}^{KL - 1} {X}_{kL - 1} ) \qquad ( 4 )$$

Accordingly, the product result of C*X in equation (4) can be obtained by adding up K partial products. The lower bound of each partial product can normalized to i=0 using a multiple of displacement L (i.e., in bits), which can be expressed by equation (5):

$${\underbrace{C * X}}_{MxN} = {\underbrace{C * {\sum }_{i = 0}^{L - 1} {2}^{i} * {X}_{i}}}_{MxL} + {2}^{L} * C * {\underbrace{{\sum }_{l = 0}^{L - 1} {2}^{i} * {X}_{i + L}}}_{MxL} + … + {2}^{( k - 1 ) L} * {\underbrace{c * ( {\sum }_{i = 0}^{L - 2} {2}^{i} {X}_{i + ( K - 1 ) L} - {2}^{L - 1} {X}_{KL - 1} )}}_{MxL} \qquad ( 5 )$$

In equation (5), each partial product of (M bits×L bits) includes two inputs, where the first input is a constant C, and the second input is a bit pattern (X_{L}*₍ⱼ₊₁₎₋₁, X_{L}*₍ⱼ₊₁₎₋₂, . . . , X_{L}*_{(j+1)-L}). Accordingly, it can be understood that this kind of partial product can be realized by a general product pre-calculation circuit, which can output 2^{L} data at the same time, and multiple multiplexers using bit patterns (X_{L}*₍ⱼ₊₁₎₋₁, X_{L}*₍ⱼ₊₁₎₋₂, . . . , X_{L}*_{(j+1)-L}) as selection signals can be connected subsequent to the product pre-calculation circuit.

In signed multiplication, the most significant partial product requires a special product pre-calculation circuit. According to equation (5), the output value of each multiplexer can be shifted with appropriate weight, and the shifted partial products are added up to obtain the final result of the constant multiplication. In brief, the aforementioned method can reduce the number of partial products from N to K, where N=K*L.

In the embodiment of FIG. 1, for convenience of description, it is assumed that M=N=16, and L=2, and K=8. Accordingly, equation (5) can be rewritten to equation (6):

$${\underbrace{C * X}}_{MxN} = {\sum }_{j = 0}^{7} {2}^{{2}^{*} j} {\underbrace{C * {\sum }_{i = 0}^{1} {2}^{i} * {X}_{i + {2}^{*} j}}}_{16 x 2} \qquad ( 6 )$$

Equation (6) can be implemented by the constant multiplier shown in FIG. 1. For example, the constant multiplier 100 includes a product pre-calculation circuit 110, a plurality of multiplexers 121-128, and a plurality of adders 131-137.

The product pre-calculation circuit 110 is configured to simultaneously generate multiple (e.g., 2L) integer multiples of the constant C, such as 0, C, 2C, and 3C. The value of 2C can be obtained by left-shifting the binary value of the constant C by one zero. The value of 3C can be obtained by adding the values of C and 2C with a 16-bit adder. Therefore, the values of 0, C, 2C, and 3C can be represented by 18-bit binary numbers. Accordingly, the circuit latency of the product pre-calculation circuit 110 is the latency of a 16-bit adder.

The multiplexers 121-128 are all 2^{L-}to-1 multiplexers, which indicates that each multiplexer includes 2^{L} data terminals and L control terminals. Each of the multiplexers 121-128 in FIG. 1 is a 4-to-1 multiplexer, and may include control terminals C0 and C1, and data terminals S0 to S3. The values 0, C. 2C, and 3C (e.g., 18-bit binary numbers) of integer multiplies of the constant C output by the product pre-calculation circuit 110 are input to the data terminals S0 to S3 of the multiplexers 121-128, respectively. For the i-th multiplexer, its control terminal is (X₂*ᵢ₊₁, X₂*ᵢ), where i is an integer from 0 to 7 (i.e., from 0 to K−1). Accordingly, the bits [1:0], [3:2], [5:4], [7:6], [9:8], [11:10], [13:12], and [15:14] of the signed number X are respectively input to the control terminals C0 and C1 of the multiplexers 121 to 128.

The multiplexers 121 to 128 respectively generate output signals P0[17:0], P1[17:0], P2[17:0], P3[17:0], P4[17:0], P5[17:0], P6[17:0], and P7[17:0], and these output signals are left-shifted by 0 (L*0), 2 (L*1), 4 (L*2), 6 (L*3), 8 (L*4), 10 (L*5), 12 (L*6), and 14 (L*7) bits to obtain the shifted output signal PS0[17:0], PS1[19:0], PS2[21:0], PS3[23:0], PS4[25:0], PS5[27:0], PS6[29:0], and PS7[31:0], which means that every two adjacent segments are separated by L bits in sequence. It should be noted that the aforementioned left-shifting operation does not require special hardware design on the circuit. Instead, a direct wire drawing method is used to add the number of left-shifted bits of 0's after the least-significant bit of each segment.

The adders 131-137 are all (M+L)-bit adders, that is, 18-bit adders. The adders are serially connected in sequence to add the shifted output signals corresponding to the multiplexers 121-128 to obtain the product M. For example, the partial product M[1:0] can be obtained using the shifted output signal PS0[1:0]. The adder 131 adds the shifted output signals PS0[17:2] and PS[19:2] to obtain a sum signal S0[17:0], and the partial product M[3:2] is the sum signal S0[1:0]. The adders 132-127 can be connected in series in a similar manner to obtain the corresponding sum signals S1[17:0] to S6[17:0], and partial products M[5:4], M[7:6], M[9:8], M[11:10], M[13:12], and M[31:14] correspond to the partial sum signals S1[1:0], S2[1:0], S3[1:0], S4[1:0], S5[1:0], and S6[17:0]. Through the structural design of the constant multiplier in FIG. 1, the result of equation (6) can be obtained.

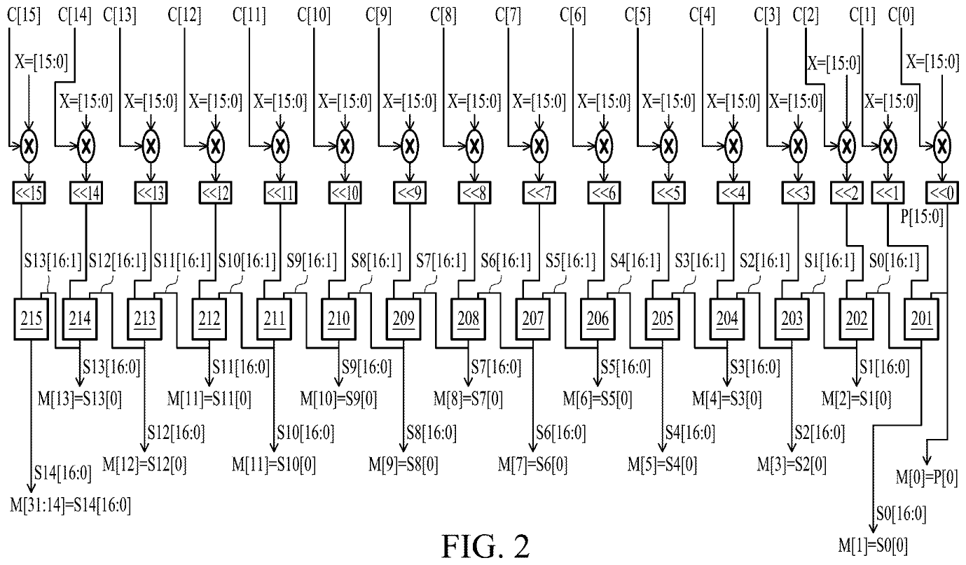

FIG. 2 is a diagram of a conventional constant multiplier.

If calculation of multiplying the 16-bit signed number by the 16-bit constant C is implemented by a conventional 16×16 multiplier, the conventional 16×16 multiplier can be represented by the constant multiplier 200 shown in FIG. 2. In brief, in the constant multiplier 200, a logical AND operation and a shifting operation are performed on the signed number X [15:0] with each bit of the constant C to obtain the corresponding partial product P. Each of the 16-bit adders 201 to 215 uses a ripple adder to sequentially add each partial product P to obtain each bit of the product M.

Because a 16-bit adder can be regarded as 16 1-bit full adders, the conventional constant multiplier 200 requires a total of 16*16=256 AND gates, and 15*16=240 full adders. In addition, because the aforementioned logical AND operations are executed in parallel in the hardware circuit of the conventional constant multiplier 200, the overall latency of the constant multiplier 200 is the latency of a single AND gate plus the latency of 240 full adders.

Please refer to FIG. 1 again, the circuit latency of the product pre-calculation circuit 110 is the latency of a 16-bit adder (i.e., for calculating the value of 3C), and the values of 0, C, and 2C can be realized by shifted hardware wires, so no additional hardware circuit is required nor does it have any latency. For the multiplexers 121-128, because the width of the output signal of each multiplexer 121-128 is 18 bits, the constant multiplier 100 needs a total of 8*18=144 4-to-1 1-bit multiplexer.

Thus, for the constant multiplier 100, a total of seven 18-bit adders and 187+16=142 1-bit full adders are required. The circuit area of the constant multipliers 100 and 200 are shown in Table 1:

TABLE 1

| | | | | Total Area | |
|---|---|---|---|---|---|
| | | Cell Number | | (μm²) | |
| | Cell | Constant | Constant | Constant | Constant |
| | Area | multiplier | multiplier | multiplier | multiplier |
| | (μm²) | 200 | 100 | 200 | 100 |
| AND | 1.8 | 256 | 0 | 460.8 | 0 |
| gate | | | | | |
| 4-to-1 | 8.64 | 0 | 144 | 0 | 1244.16 |
| MUX | | | | | |
| 1-bit | 10.8 | 240 | 142 | 2592 | 1533.6 |
| full | | | | | |
| adder | | | | | |
| | | | | 3052.8 | 2777.76 |

For example, Table 1 is calculated using the cell area of a standard-cell library of 55 nm. Accordingly, in comparison with the convention constant multiplier 200, the total circuit area of the constant multiplier 100 in the present invention is smaller. In addition, the total latency of the constant multiplier 100 can be regarded as the latency of a 4-to-1 multiplier plus the latency of 142 1-bit full adders. However, the conventional constant multiplier 200 requires the latency of one AND gate plus the latency of 240 1-bit full adders. Therefore, the constant multiplier 100 of the present invention can greatly reduce the latency.

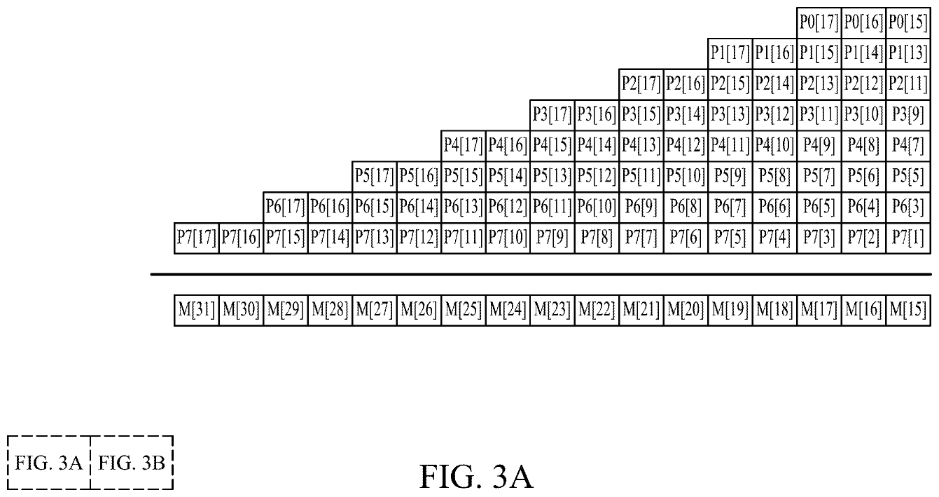

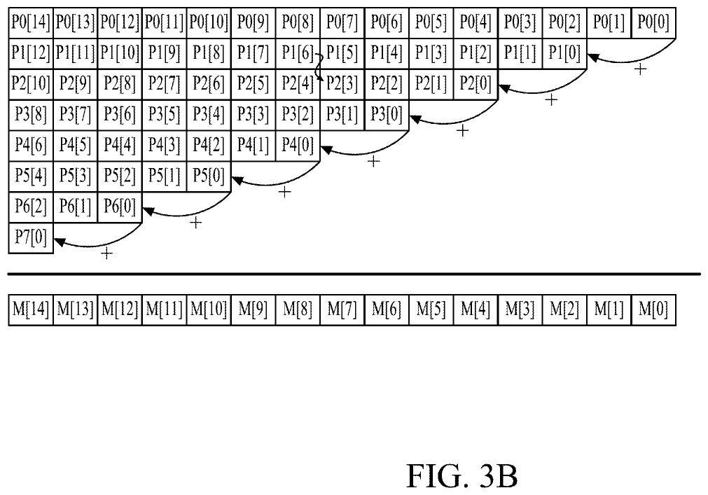

FIGS. 3A-3B are portions of a diagram of the ripple adder architecture in accordance with the embodiment of FIG. 1. Please refer to FIG. 1 and FIGS. 3A-3B.

The constant multiplier 100 in FIG. 1 may use seven 18-bit adders that are connected in series to perform a ripple addition on the shift output signal of each multiplexer 121-128 to obtain the product M, wherein the architecture of the ripple adder can be shown in FIGS. 3A-3B, and the structure shown in FIGS. 3A-3B already includes the shifting operations of the output signals of the multiplexers 121-128. In brief, the 1-bit full adders serially connected in sequence in each 18-bit adder need to wait for the carry bit of the previous full adder to be generated before calculation. Therefore, the latency of the ripple-adder architecture depends on the number of 1-bit full adders, which means the latency of the architecture shown in FIGS. 3A-3B is the latency of 7*18=126 1-bit full adders.

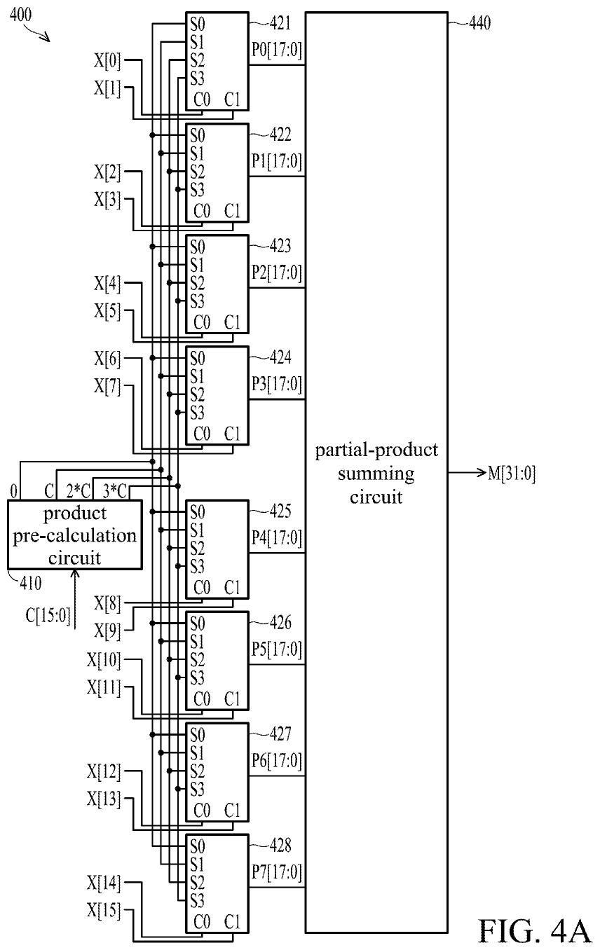

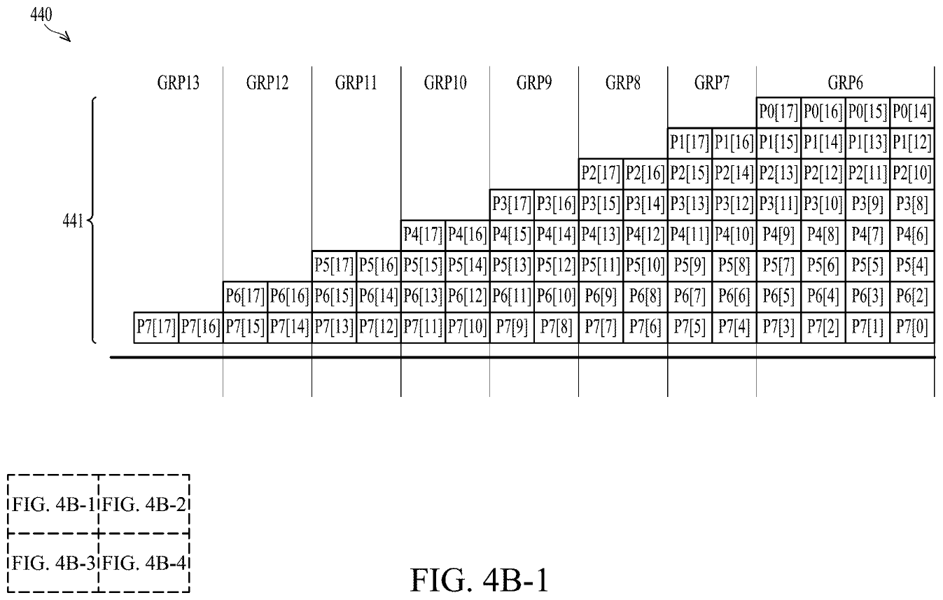

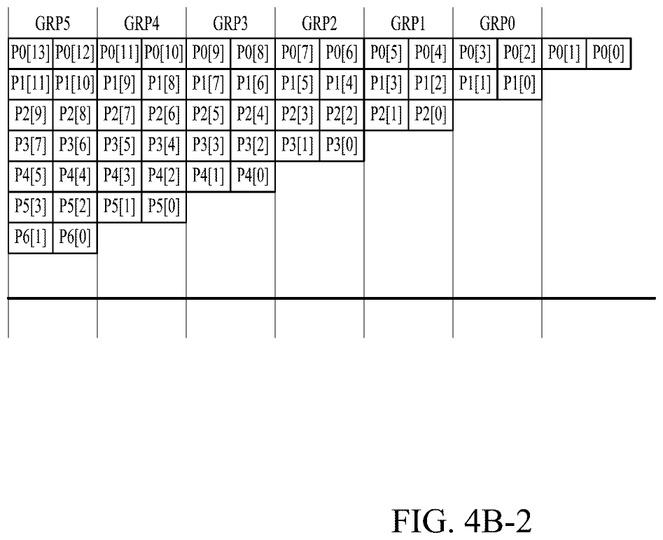

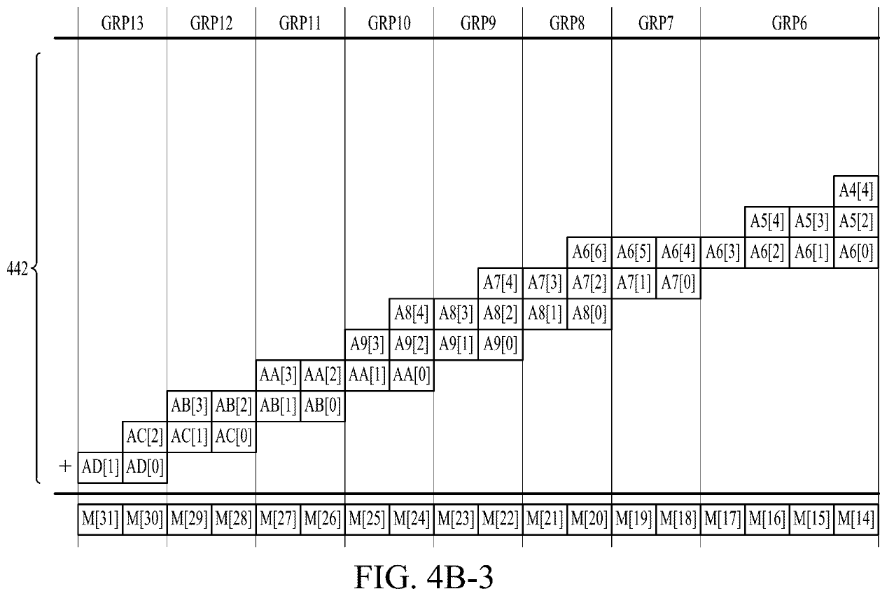

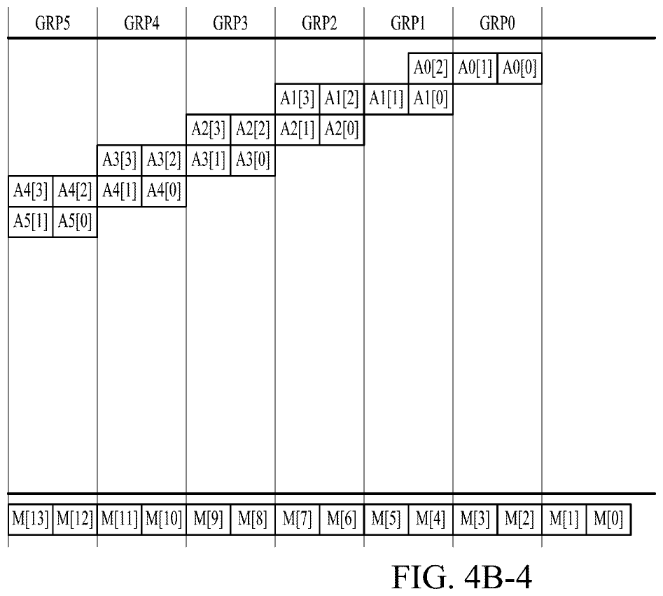

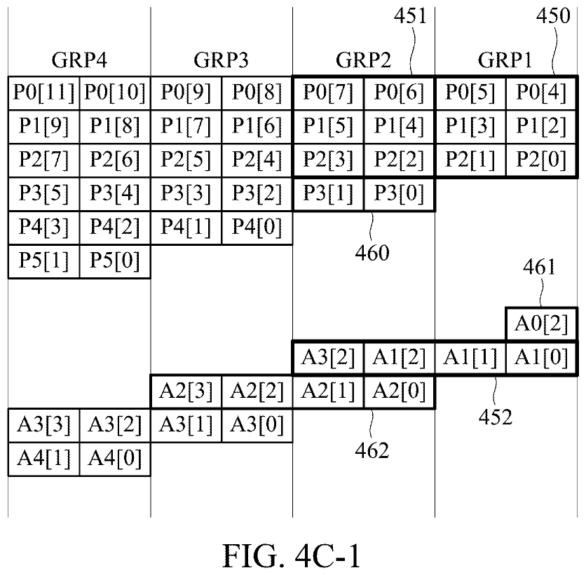

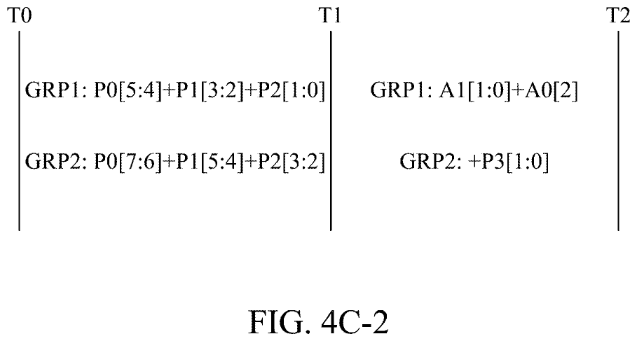

FIG. 4A is a diagram of the constant multiplier in accordance with another embodiment of the invention. FIGS. 4B-1 to 4B-4 are portions of a diagram of the partial product summing circuit in accordance with the embodiment of FIG. 4A. FIGS. 4C-1 to 4C-2 are portions of a diagram of carry calculation and group summation in accordance with the embodiment of FIGS. 4B-1 to 4B-4.

In another embodiment, the circuit architecture of the constant multiplier 400 in FIG. 4A is similar to that of the constant multiplier 100 in FIG. 1, and the different is that the seven 18-bit adders in the constant multiplier 100 are replaced by the partial-product summing circuit 440, as shown in FIG. 4A.

The architecture of the partial-product summing circuit 440 is shown in FIGS. 4B-1 to 4B-2. For example, the architecture of partial-product summing can be divided into 14 groups from GRP0 to GRP13, for example, divided into K groups, and the length of each group is L bits.

Each of the groups GRP0 to GRP13 has corresponding partial-product sums A0 to AD, and calculations of the partial-product sums A0 to AD are shown in Table 2:

TABLE 2

Partial-product sum groups
A0[2: 0] = P0[3: 2] + P1[1: 0]
A1[3: 0] = P0[5: 4] + P1[3: 2] + P2[1: 0]
A2[3: 0] = P0[7: 6] + P1[5: 4] + P2[3: 2] + P3[1: 0]
A3[3: 0] = P0[9: 8] + P1[7: 6] + P2[5: 4] + P3[3: 2] + P4[1: 0]
A4[4: 0] = P0[11: 10] + P1[9: 8] + P2[7: 6] + P3[5: 4] + P4[3: 2] +
P5[1: 0]
A5[4: 0] = P0[13: 12] + P1[11: 10] + P2[9: 8] + P3[7: 6] +
P4[5: 4] + P5[3: 2] + P6[1: 0]
A6[6: 0] = P0[17: 14] + P1[15: 12] + P3[13: 10] + P3[11: 8] +
P4[9: 6] + P5[7: 4] + P6[5: 2] + P7[3: 0]
A7[4: 0] = P1[17: 16] + P2[15: 14] + P3[13: 12] + P4[11: 10] +
P5[9: 8] + P6[7: 6] + P7[5: 4]
A8[4: 0] = P2[17: 16] + P3[15: 14] + P4[13: 12] + P5[11: 10] +
P6[9: 8] + P7[5: 4]
A9[3: 0] = P3[17: 16] + P4[15: 14] + P5[13: 12] + P6[11: 10] +
P7[9: 8]
AA[3: 0] = P4[17: 16] + P5[15: 14] + P6[13: 12] + P7[11: 10]
AB[3: 0] = P5[17: 16] + P6[15: 14] + P7[13: 12]
AC[2: 0] = P6[17: 16] + P7[15: 14]
AD[1: 0] = P7[17: 16]

The partial-product sums A0 to AD shown in Table 2 correspond to region 441 in FIGS. 4B-1 to 4B-4. In brief, each first adder in region 441 calculates the first sum of the shifted output signal of each multiplexer in each segment in parallel, and the first sum corresponding to every two adjacent segments is separated by L bits. In this embodiment, L=2.

According to the equations in Table 2, the final sum result M[31:0] of the partial products sums A0 to AD and the carry value of each group can be further derived, as shown in Table 3:

TABLE 3
Groups in the final sum result

M[1: 0] = P0[1: 0]
M[3: 2] = A0[1: 0]
{C5, M[5: 4]} = A0[2] + A1[1: 0]
{C7, M[7: 6]} = A1[3: 2] + A2[1: 0] + C5
{C9, M[9: 8]} = A2[3: 2] + A3[1: 0] + C7
{C11, M[11: 10]} = A3[3: 2] + A4[1: 0] + C9
{C13, M[13: 12]} = A4[3: 2] + A5[1: 0] + C11
{C17, M[17: 14]} = A4[4] + A5[4: 2] + A6[3: 0] + C13
{C19, M[19: 18]} = A6[5: 4] + A7[1: 0] + C17
{C21, M[21: 20]} = A6[6] + A7[3: 2] + A8[1: 0] + C19
{C23, M[23: 22]} = A7[4] + A8[3: 2] + A9[1: 0] + C21
{C25, M[25: 24]} = A8[4] + A9[3: 2] + AA[1: 0] + C23
{C27, M[27: 26]} = AA[3: 2] + AB[1: 0] + C25
{C29, M[29: 28]} = AB[3: 2] + AC[1: 0] + C27
M[31: 30] = AC[2] + AD[1: 0] + C29

The equations of the final sum result M[31:0] and the carry bit of each group corresponds to regions 441 and 442 shown in FIGS. 4B-1 and 4B-4. In brief, each second adder in region 442 calculates the second sum of the first sum of each first adder in each segment in parallel to obtain a partial value of the product M in each segment.

Specifically, because the partial products P0 to P7 are calculated at the same time, and the calculation of the partial product sums A0 to AD depends on the partial products P0 to P7, the partial products sums A0 to AD can be calculated in parallel, and it will not cause additional latency in the summing operation of the partial-product sums A0 to AD. In addition, the latency of the architecture shown in FIGS. 4B-1 to 4B-4 is mainly from the calculations of carry values C5 to C29 and M[31], and the latency of carry propagation in the last group is hidden in the sum operation of each group.

Please refer to FIGS. 4C-1 to 4C-2, and the summing operation of groups GRP1 and GRP2 is used as an example for description. Assuming that the summing operation of groups GRP1 and GRP2 starts at time T0. When the time reaches T1, the summing operation of the group GRP1 has been completed, for example, the summing operation of block 450. However, for group GRP2, at time T1, the summing operation of group GRP2 only completes the first three items (e.g., block 451), and the last item P3[1:0] should be added to obtain the total result of group GRP2. Therefore, during the interval from time T1 to time T2, the addition operation of the last item of group GRP2 can be completed (e.g., block 460).

In the same interval, the calculation for the carry bit of group GRP1 has also been completed (e.g., blocks 461 and 452). If the latency of the carry-bit calculation of group GRP1 is the same as that of the addition operation of the last item in group GRP2, the calculation of the carry bit for group GRP2 can be seamlessly completed, which means that the calculation of the carry bit for the previous group (e.g., group K−1) can be partially overlap with the summing operation of the current group (e.g., group K) to reduce the overall latency of the partial-product summing circuit 440, where K is a positive integer. In a similar manner, the latency of the carry bit for each group in the partial-product summing circuit 440 can be derived, wherein the latency of the carry bit for each group can be represented by Table 4:

TABLE 4

| | latency of carry |
|---|---|
| | bits (the number |
| | of 1-bit full |
| Groups in the final sum result | adders) |
| M[1: 0] = P0[1: 0] | 0 |
| M[3: 2] = A0[1: 0] | 0 |
| {C5, M[5: 4]} = A0[2] + A1[1: 0] | 0 |
| {C7, M[7: 6]} = A1[3: 2] + A2[1: 0] + C5 | 3 |
| {C9, M[9: 8]) = A2[3: 2] + A3[1: 0] + C7 | 3 |
| {C11, M[11: 10]} = A3[3: 2] + A4[1: 0] + C9 | 3 |
| {C13, M[13: 12]} = A4[3: 2] + A5[1:0] + C11 | 3 |
| {C17, M[17: 14]} = A4[4] + A5[4: 2] + A6[3: 0] + C13 | 5 |
| {C19, M[19: 18]} = A6[5: 4] + A7[1: 0] + C17 | 3 |
| {C21, M[21: 20]} = A6[6] + A7[3: 2] + A8[1: 0] + C19 | 3 |
| {C23, M[23: 22]} = A7[4] + A8[3: 2] + A9[1: 0] + C21 | 3 |
| {C25, M[25: 24]} = A8[4] + A9[3: 2] + AA[1: 0] + C23 | 3 |
| {C27, M[27: 26]} = AA[3: 2] + AB[1: 0] + C25 | 3 |
| {C29, M[29: 28]} = AB[3: 2] + AC[1: 0] + C27 | 3 |
| M[31: 30] = AC[2] + AD[1: 0] + C29 | 2 |
| Total latency (the number of 1-bit full adder) | 37 |

Accordingly, the overall latency of the partial-product summing circuit 440 is the latency of 37 1-bit full adders. In comparison with the ripple-addition architecture shown in FIGS. 3A-3B, the overall latency of the partial-product summing circuit 440 in FIG. 4A can be reduced from the latency of 126 1-bit full adders to 37 1-bit full adders. In short, the partial-product summing circuit 440 in FIG. 4A can achieve the following points: (1) the partial-product summing operation is divided into multiple groups; (2) the addition operations of each group can be executed simultaneously; (3) the sum result of each group is shifted; (4) the shifted sum result of each group is summed up to obtain the final product result. Because all partial products can be obtained simultaneously, the summing operation of each group can be executed in parallel. In addition, the latency of the additional addition operation of the current group can overlap with the calculation of carry propagation of the previous group, so the overall latency of the partial product summing circuit 440 can be reduced.

Accordingly, the overall latency of the constant multiplier 400 in FIG. 4A is the latency of one 16-bit adder (i.e., for calculating the value of 3C) plus an 18-bit 4-to-1 multiplexer plus 37 1-bit full adders. Accordingly, in comparison with the conventional constant multiplier 200 in FIG. 2, the constant multiplier 400 in FIG. 4A can greatly reduce the latency, for example, from the latency of 240 1-bit full adders to 37 1-bit full adders. In addition, in comparison with the conventional constant multiplier 200 in FIG. 2, the constant multiplier 400 in FIG. 4A can reconfigure the order of the summing sequence, and can be implemented with a small additional hardware circuit cost (e.g., the product pre-calculation circuit).

In addition, it should be noted that the constant C in the constant multiplier 100 in FIG. 1 or the constant multiplier 400 in FIG. 4A is an adjustable value, so a reconfigurable function can be achieved.

In view of the above, a reconfigurable low-latency constant multiplier is provided in the present invention, which can reduce the number of partial products and the latency of the summing operation of the partial products. Therefore, the constant multiplier in the present invention can provide faster computing performance.

Words such as “first”, “second”, and “third” are used in the scope of patent application to modify the elements in the scope of patent application, and are not used to indicate that there is an order of priority and antecedent relationship between them. Either one element precedes another element, or the chronological order when performing method steps, only used to distinguish elements with the same name.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A constant multiplier, for calculating a product of a constant C and an input value X, wherein the constant C is N bits and the input value X is M bits, and the input value X is divided into K groups, and each group has a length of L bits, where N, M, K, and L are positive integers, the constant multiplier comprising:
a product pre-calculation circuit, configured to generate a plurality of integer multiples of the constant C;
K multiplexers, wherein a selection signal of the j-th multiplexer of the K multiplexers corresponds to bits ((j+1)*L−1:j*L) of the input value X, and an input signal of each multiplexer is one of the integer multiples of the constant C, and an output signal of the j-th multiplexer is left-shifted by j*L bits to generate a shifted output signal, where j is an integer between 0 and K−1; and
(K−1) adders, wherein each adder is connected in series to sum up the shifted output signal corresponding to each multiplexer to obtain the product.

2. The constant multiplier as claimed in claim 1, wherein the constant C is an adjustable value.

3. The constant multiplier as claimed in claim 1, wherein the integer multiples of the constant C are values from 0 to 2^{L}−1 multiples of the constant C.

4. The constant multiplier as claimed in claim 1, wherein each adder is an (M+L)-bit adder.

5. The constant multiplier as claimed in claim 4, wherein the least two significant bits of the products are bits (L−1:0) of the shifted output signal of the 0-th multiplexer.

6. The constant multiplier as claimed in claim 5, wherein p is an integer between 0 to K−2, and when p is between 0 and K−3, the shifted output signal of the p-th multiplexer and the shifted output signal of the (p+1)-th multiplexer are input to the p-th adder to obtain bits ((p+1)*L−1:p*L) of the product.

7. The constant multiplier as claimed in claim 6, wherein when p is equal to K−2, the shifted output signal of the p-th multiplexer and the shifted output of the (p+1)-th multiplexer are input to the p-th adder to obtain bits (M*N−1:M*N−L−1) of the product.

8. A constant multiplier, for calculating a product of a constant C and an input value X, wherein the constant C is N bits and the input value X is M bits, and the input value X is divided into K groups, and each group has a length of L bits, where N, M, K, and L are positive integers, the constant multiplier comprising:
a product pre-calculation circuit, configured to generate a plurality of integer multiples of the constant C;
K multiplexers, wherein a selection signal of the j-th multiplexer of the K multiplexers corresponds to bits ((j+1)*L−1:j*L) of the input value X, and an input signal of each multiplexer is one of the integer multiples of the constant C, and an output signal of the j-th multiplexer is left-shifted by j*L bits to generate a shifted output signal, the shifted output signal corresponding to each multiplexer is divided into a plurality of segments, and every two adjacent segments are separated by L bits, where j is an integer between 0 and K−1; and
a partial-product summing circuit, comprising:
a plurality of first adders, wherein each first adder calculates a first sum of the shifted output signal of each multiplexer in each segment in parallel, and the first sum corresponding to every two adjacent segments are separated by L bits; and
a plurality of second adders, wherein each second adder calculates a second sum of the first sum of each first adder in each segment in parallel to obtain a partial value of the product M in each segment.

9. The constant multiplier as claimed in claim 8, wherein the constant C is an adjustable value.

10. The constant multiplier as claimed in claim 8, wherein the integer multiples of the constant C are values from 0 to 2^{L}−1 multiples of the constant C.
